(19) United States
(12) Patent Application Publication
(10) Pub. No.: US 2021/0034678 A1
(43) Pub. Date: Feb. 4, 2021

(54) DIALOGUE SERVER

(71) Applicant: NTT DOCOMO, INC., Chiyoda-ku (JP)

(72) Inventors: Takanori HASHIMOTO, Chiyoda-ku (JP); Hiroshi FUJIMOTO, Chiyoda-ku (JP); Yuriko OZAKI, Chiyoda-ku (JP)

(73) Assignee: NTT DOCOMO, INC., Chiyoda-ku (JP)

(21) Appl. No.: 17/044,166

(22) PCT Filed: Feb. 13, 2019
(86) PCT No.: PCT/JP2019/005137

§ 371 Date: Sep. 30, 2020

(30) Foreign Application Priority Data
Apr. 23, 2018 (JP) 2018-082296

(51) Int. Cl. G06F 16/9032; G06F 16/903; G06F 40/30

(52) U.S. Cl. CPC G06F 16/90332; G06F 40/30; G06F 16/90344

(57) ABSTRACT

Provided is a dialogue server capable of simply reducing the amount of dialogue without manually constructing a database for reduction of dialogue in advance.

A dialogue server 100 includes a history database 105 which is a history storage unit configured to store history information based on an input performed by one user or another user, a reception unit 101 configured to receive an input sentence from a user terminal 200 of the one user and acquires an input keyword therefrom, a search unit 102 configured to perform a search on the basis of the input keyword and the history information when the input keyword is acquired, and a transmission unit configured to transmit response content (a question sentence candidate) based on a search of the search unit 102 to the user terminal 200.

### TECHNICAL FIELD

The present invention relates to a dialogue server that performs a search on the basis of an input keyword.

### BACKGROUND ART

Patent Literature 1 discloses a question reply control program for controlling an output of a reply to a question described in a natural sentence, avoiding risk of selecting a reply which is not in accord with a client's question intention, and efficiently narrowing down replies. Specifically, Patent Literature 1 discloses that, in a case where search results of a predetermined number of cases are obtained in performing an FAQ search, the number of cases is narrowed down by asking reverse questions or related questions.

### CITATION LIST

### Patent Literature

[Patent Literature 1] Japanese Unexamined Patent Publication No. 2015-36945

### SUMMARY OF INVENTION

### Technical Problem

However, in the technique disclosed in Patent Literature 1, questions and replies thereto need to be managed according to categories in order to efficiently perform a dialogue for an FAQ search. Therefore, there is a problem in that it takes much time and effort to create questions and replies thereto.

Consequently, in order to solve the above problem, an object of the present invention is to provide a dialogue server capable of simply reducing the amount of dialogue without manually constructing a database for reduction of dialogue in advance.

### Solution to Problem

According to the present invention, there is provided a dialogue server configured to perform a response for prompting a user to make an additional input with respect to the user's input and provide response content according to the user's input, the dialogue server including: a history storage unit configured to store history information based on an input performed by one user or another user; an acceptance unit configured to accept an input keyword from a user terminal of the one user; a search unit configured to perform a search on the basis of the input keyword and the history information when the input keyword is accepted; and a transmission unit configured to transmit response content based on a search of the search unit to the user terminal.

With such a configuration, it is possible to perform a search on the basis of history information in addition to an input keyword, and thus a further input of an input keyword is made unnecessary. Thus, it is possible to reduce the amount of dialogue for a search.

### Advantageous Effects of Invention

According to the present invention, it is possible to reduce the amount of dialogue for a search.

### BRIEF DESCRIPTION OF DRAWINGS

FIG. 1 is a block diagram illustrating a functional configuration of a dialogue server 100 of the present embodiment.

FIG. 2 is a diagram illustrating a specific example of a history database 105.

FIG. 3 is a diagram illustrating a specific example of a truth table database 107.

FIG. 4 is a sequence diagram illustrating processing (affirmative intention) of the dialogue server 100 and a user terminal 200.

FIG. 5 is a diagram illustrating a specific example of a dialogue screen in the user terminal 200.

FIG. 6 is a sequence diagram illustrating processing (negative intention) of the dialogue server 100 and the user terminal 200.

FIG. 7 is a diagram illustrating a specific example of a dialogue screen in a case where a negative intention is shown with respect to a return question keyword.

FIG. 8 is a diagram illustrating an example of a dialogue screen when a question sentence candidate is transmitted without sending a return question keyword in response to an input keyword.

FIG. 9 is a diagram illustrating a specific example of a history database 105 in a modification example.

FIG. 10 is a sequence diagram illustrating processing of the dialogue server 100 in a modification example.

FIG. 11 is a diagram illustrating a hardware configuration of the dialogue server 100.

### DESCRIPTION OF EMBODIMENTS

An embodiment of the present invention will be described with reference to the accompanying drawings. The same components are denoted, if possible, by the same reference numerals and signs, and thus description thereof will not be repeated.

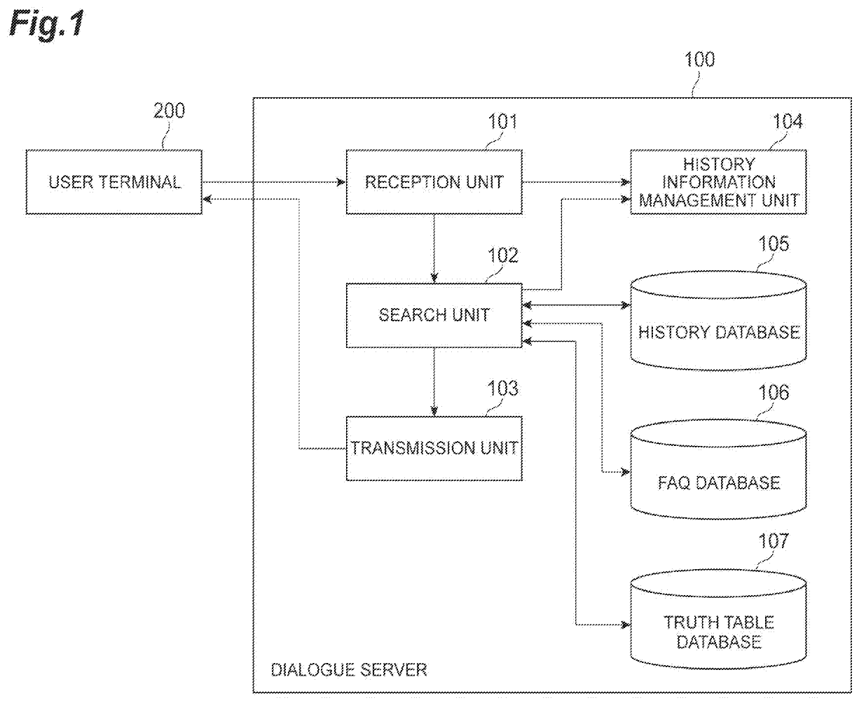

FIG. 1 is a block diagram illustrating a functional configuration of a dialogue server 100 of the present embodiment. The dialogue server 100 is a device that searches for question sentence candidates which are response content according to an input keyword transmitted from a user terminal 200 and transmits the candidates found through the search to the user terminal 200. For example, this dialogue server is used in an FAQ search system. A user inputs an input sentence to this the dialogue server 100, and thus can search for its corresponding question sentence and a reply thereto.

As shown in FIG. 1, the dialogue server 100 is configured to include a reception unit 101 (acceptance unit), a search unit 102, a transmission unit 103, a history information management unit 104, a history database 105, an FAQ database 106 and a truth table database 107.

The reception unit 101 is a portion that acquires an input keyword from an input sentence which is transmitted from the user terminal 200 or receives indication information indicating an affirmative or negative intention with respect to a return question keyword, to thereby acquire the return question keyword as the input keyword.

The search unit 102 is a portion that searches the truth table database 107 on the basis of an affirmative or negative indication of the input keyword or the return question keyword received by the reception unit 101, and history information stored in the history database 105. For example, the search unit 102 searches the truth table database 107 using an input keyword and a keyword described as history information, and searches question sentence candidates associated with a search keyword which is coincident with the input keyword. Meanwhile, in a case where the reception unit 101 acquires a plurality of input keywords, the coincidence of all the input keywords is determined. However, in a case where there are no input keywords of which all are coincident, a search is performed using some input keywords satisfying a predetermined condition (for example, by selecting input keywords that make it possible for the number of question sentence candidates to be narrowed down to a predetermined number or less).

In a case where the search unit 102 searches for a plurality of question sentence candidates without narrowing down the question sentence candidates, the search unit acquires a search keyword satisfying a predetermined condition from the truth table database 107. The transmission unit 103 transmits the acquired search keyword as a return question keyword, and waits for an affirmative or negative indication from the user.

The transmission unit 103 is a portion that transmits response content searched for by the search unit 102 to the user terminal 200. In addition, the transmission unit 103 transmits a return question key for prompting the user to make an additional input.

The history information management unit 104 is a portion that acquires response content (question sentence candidate) in which an affirmative indication is accepted by the user in the response content (question sentence candidates) searched for by the search unit 102, and stores the acquired response content in the history database 105 together with the search keyword. In addition, the history information management unit 104 is a portion that stores an input keyword acquired by the reception unit 101, a return question keyword and affirmative or negative intention information in the history database 105.

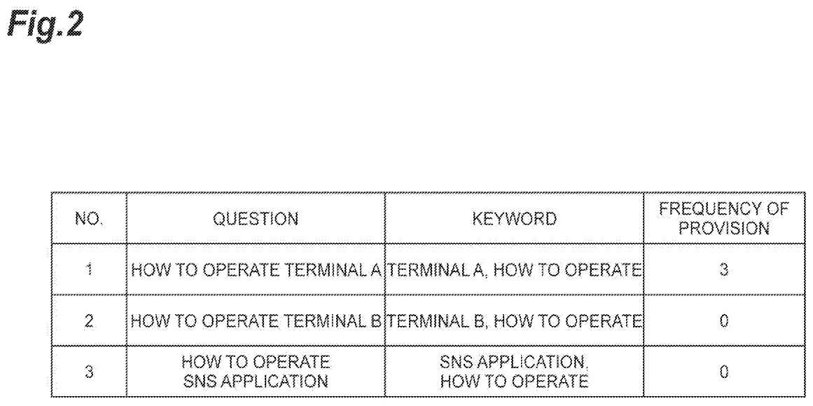

The history database 105 is a portion that stores a search history of the user terminal 200. Specifically, the history database 105 stores a question sentence (response content) provided to the user in the past, a search keyword associated with the question sentence, and the frequency of provision thereof. FIG. 2 is a diagram illustrating a specific example of this. As shown in FIG. 2, question sentences, search keywords, and the frequency of provision thereof are stored in association with each other. The question sentences and the search keywords are acquired from the truth table database 107 by the history information management unit 104. Meanwhile, the history database 105 stores search histories of users other than the one user.

The FAQ database 106 is a database that stores a question sentence which is response content and a reply thereto. The FAQ database 106 is created by an operator of the FAQ system in advance.

The truth table database 107 is a database that stores question sentences which are response content and search keywords extracted from the question sentences. The truth table database 107 is a database which is used for a search, and is created by a manager of the FAQ system or created on the basis of words extracted in accordance with a known natural language analysis algorithm.

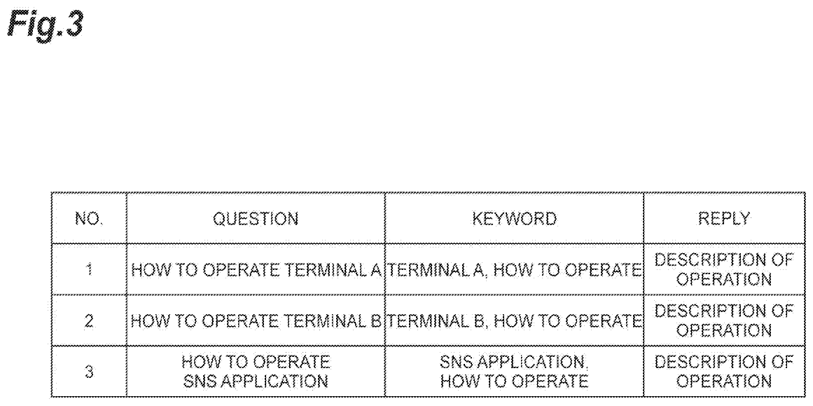

FIG. 3 is a diagram illustrating a specific example of the truth table database 107. As shown in FIG. 3, a question sentence and one or a plurality of search keywords are described.

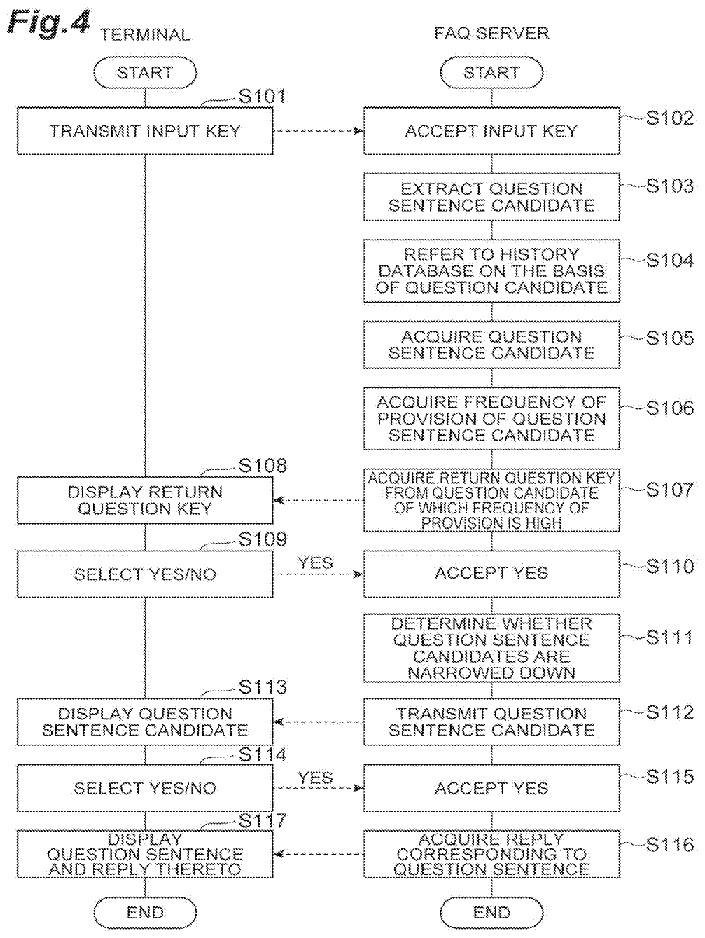

Operations of the dialogue server 100 configured in this manner will be described. FIG. 4 is a sequence diagram illustrating processing of the dialogue server 100 and the user terminal 200.

In the user terminal 200, an input sentence is input and transmitted by the user (S101).

In the dialogue server 100, the reception unit 101 acquires an input keyword by receiving an input sentence and performing a language analysis process (such as a morphological analysis) from the input sentence (S102). The search unit 102 searches the truth table database 107 using the input keyword, and acquires one or a plurality of question sentence candidates (S103). Meanwhile, in this step, the term “question sentence candidate” is used because it is a candidate, but a question sentence and its content do not change.

The search unit 102 refers to the history database 105 on the basis of the acquired question sentence candidates (S104), and acquires a question sentence candidate included in the history database 105 among the acquired question sentence candidates (S105).

The search unit 102 acquires the frequency of provision of a question sentence candidate from the history database 105 (S106).

Here, the search unit 102 acquires one question sentence candidate of which the frequency of provision is highest.

The search unit 102 refers to the truth table database 107, and acquires one search keyword as a return question keyword among search keywords corresponding to the one acquired question sentence candidate (S107). For example, in acquiring one search keyword, the search unit 102 selects a search keyword that makes it possible to uniquely narrow down question sentence candidates, or a search keyword having a high frequency of selection as a return question keyword, or the like. Meanwhile, a selection criterion for a return question keyword is not limited thereto and may be random.

The user terminal 200 receives a return question keyword, and displays the return question keyword on a display unit (not shown) (S108). The user terminal 200 accepts the selection of either of an affirmative intention (YES) or a negative intention (NO) with respect to the return question keyword in accordance with the user's operation, and transmits that effect (S109). Here, the user terminal 200 transmits an affirmative intention.

In the dialogue server 100, when the reception unit 101 receives an affirmative intention (S110), the search unit 102 determines whether it is necessary to further narrow down question sentence candidates (search for a plurality of question sentence candidates) (S111). In the present embodiment, the search unit 102 determines further narrowing down to be unnecessary, and the transmission unit 103 transmits one question sentence candidate (S112).

The user terminal 200 displays a question sentence candidate (S113), and accepts affirmation or negation with respect to the question sentence candidate through the user's operation (S114).

In the dialogue server 100, the reception unit 101 receives an affirmative or negative intention (S115). Here, since an affirmative intention is received, the search unit 102 acquires a reply to the question sentence candidate, and transmits the question sentence candidate as a question sentence to the user terminal 200 together with a reply thereto (S116).

The user terminal 200 receives and displays the question sentence and a reply thereto (S117).

Meanwhile, in process S105, in a case where it is determined that only one return question keyword candidate is left on the basis of the question sentence candidate acquired from the history database 105, that is, a case where it is determined that there is only one question sentence candidate, the remaining question sentence candidate may be transmitted without performing a process of acquiring a return question keyword in process S107.

In addition, in S103 to S105 of the sequence diagram described above, after the truth table database 107 is referred to, the history database 105 is referred to and a search is performed, but the history database 105 may be referred to first and then a search process may be performed. In that case, it may be possible to skip a process of searching the truth table database 107.

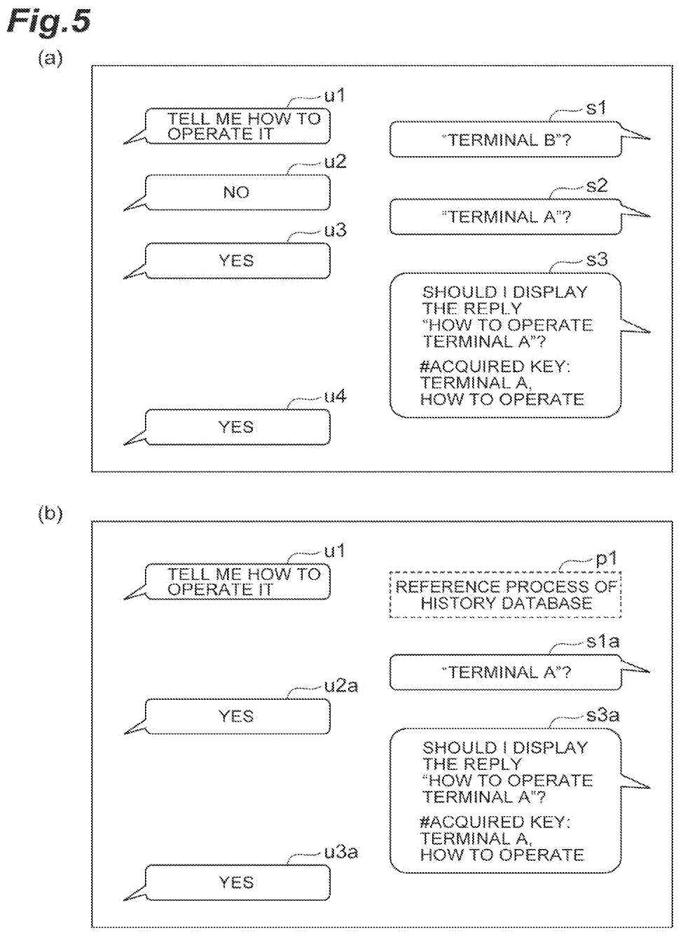

FIG. 5 shows a specific example of a dialogue screen in the user terminal 200 based on the above-described process. FIG. 5(a) shows a dialogue screen (equivalent to a method in the related art) to be processed without referring to the history database 105, and FIG. 5(b) shows a dialogue screen to be processed without referring to the history database 105.

As shown in FIG. 5(a), in the user terminal 200, the user inputs an input sentence “Tell me how to operate it” as in a balloon u1. The dialogue server 100 extracts an input keyword on the basis of this sentence, extracts “terminal B” as a return question keyword from the truth table database 107, and transmits “‘Terminal B’?” to the user terminal 200 (balloon s1).

In the user terminal 200, a negative intention is given as a reply to the return question keyword (balloon u2). In the dialogue server 100, “terminal A” which is the next return question keyword is further extracted, and “‘Terminal A’?” is transmitted to the user terminal 200 (balloon s2).

In the user terminal 200, an affirmative intention is given as a reply to the return question keyword (balloon u3). In the dialogue server 100, a question sentence candidate is extracted, and “Should I display the reply ‘how to operate terminal A’?” is transmitted to the user terminal 200 (balloon s3). Here, “terminal A” and “how to operate” are also further transmitted as acquired keys. These acquired keys indicate keywords used in a search.

In the user terminal 200, an affirmative intention is given as a reply (balloon u4). Thereafter, a reply thereto is displayed.

On the other hand, FIG. 5(b) shows a dialogue screen using the history database 105. As shown in FIG. 5(b), the dialogue server 100 performs a reference process of the truth table database 107 with respect to the balloon u1 “Tell me how to operate it” transmitted from the user terminal 200, and performs a reference process p1 of the history database 105 after one or a plurality of question sentence candidates are acquired. Meanwhile, the reference process p1 is shown on the dialogue screen for convenience of description, but not displayed in reality.

The reference process p1 is a process equivalent to process S104 in FIG. 4 described above. Here, the dialogue server 100 (the search unit 102) further refers to the history database 105, and performs a process of narrowing down question sentence candidates from one or a plurality of question sentence candidates acquired on the basis of an input keyword. In FIG. 2, “terminal A” is associated as a search keyword of the narrowed-down question sentence candidate, and the dialogue server 100 (the transmission unit 103) transmits this search keyword as a return question keyword (balloon s1a).

Subsequently, as shown in FIG. 5(b), a dialogue process is performed as shown in a balloon u2a, a balloon 3a, and a balloon u3, and question sentence candidates are narrowed down.

It can be understood that the number of steps in the dialogue process shown in FIG. 5(b) is fewer than that in the dialogue process shown in FIG. 5(a).

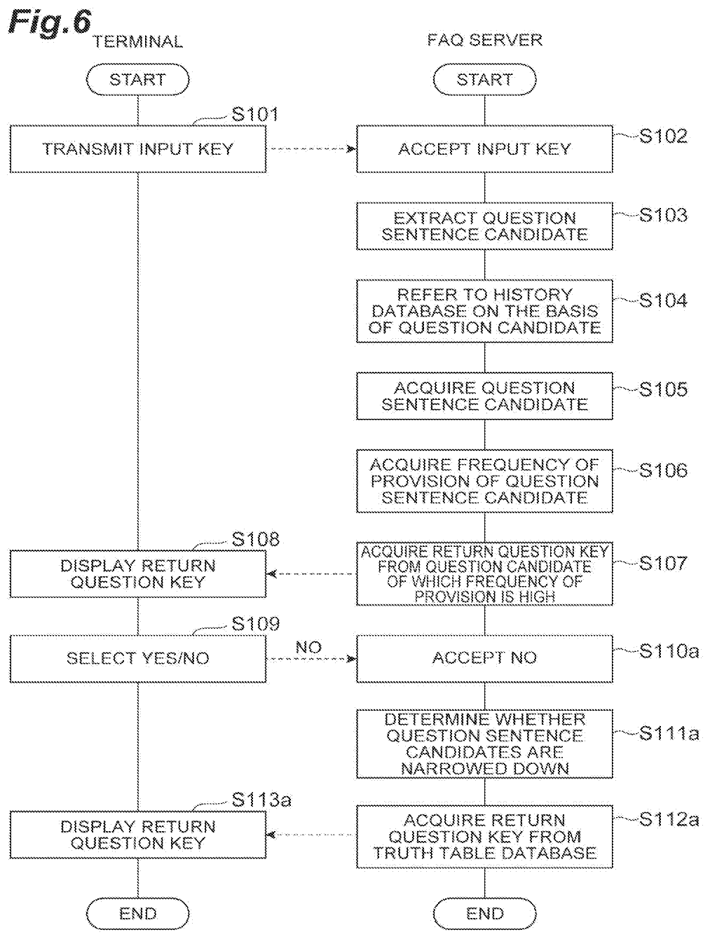

Next, processing in a case where a return question keyword acquired referring to the history database 105 is negated will be described. FIG. 6 is a sequence diagram illustrating the processing.

Processes S101 to S109 are the same as those in FIG. 4. In the dialogue server 100, when the reception unit 101 receives an indication of a negative intention for a return question keyword from the user terminal 200 (S110a), the search unit 102 determines whether question sentence candidates containing a search keyword other than the return question keyword are narrowed down to one (S111a). Here, it is determined that the question sentence candidates cannot be narrowed down, the search unit 102 further acquires another search keyword from the truth table database 107, and the transmission unit 103 transmits the acquired search keyword as a return question keyword to the user terminal 200 (S112a). Meanwhile, in process Sllla, in a case where it can be determined that question sentence candidates are narrowed down to one by receiving a negative intention, the question sentence candidate is transmitted.

For example, in a case where there are only two question sentence candidates acquired in process S105, or the like, when a return question keyword of one question sentence candidate is negated, the other question sentence candidate is highly likely to be a question sentence desired by the user. Thus, in such a case, the other may be sent as a question sentence candidate without sending a return question keyword again.

In the user terminal 200, a return question keyword is displayed (S113a), and the user performs an affirmative or negative indication with respect to the return question keyword.

Subsequently, the dialogue server 100 and the user terminal 200 repeatedly perform S107 to S113a until question sentence candidates are narrowed down. When question sentence candidates are narrowed down, the dialogue server 100 changes the narrowed-down question sentence candidates to return question keywords, and transmits them to the user terminal 200.

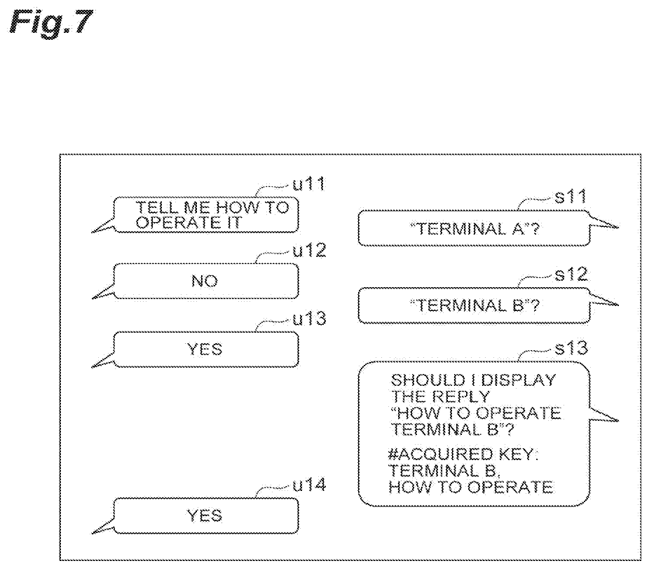

FIG. 7 shows a specific example of a dialogue screen in a case where a negative intention is shown with respect to a return question keyword acquired on the basis of the history database 105. In the user terminal 200, the user inputs “Tell me how to operate it” as in the balloon u11, and transmits it to the dialogue server 100.

In the dialogue server 100, the search unit 102 refers to the truth table database 107 and the history database 105, acquires a return question keyword “terminal A,” and transmits the acquired return question keyword to the user terminal 200 (balloon s11).

Here, in the user terminal 200, the user replies with a negative intention to the return question keyword (balloon u12).

In the dialogue server 100, the search unit 102 acquires “terminal B” as the next return question keyword, and transmits the acquired keyword (s12).

In the user terminal 200, the user replies an affirmative intention to the return question keyword (u13). Subsequently, as described above, the question sentence candidate and its intention are exchanged (balloon s13, balloon u14).

Meanwhile, in a case where a negative intention is shown with respect to the return question keyword “terminal A” (balloon u12), when the dialogue server 100 can narrow down the question sentence candidates to one, the question sentence candidate may be transmitted without transmitting the return question keyword “terminal B” (balloon s13). That is, a process of transmitting the balloon s13 may be performed with the balloon s12 skipped.

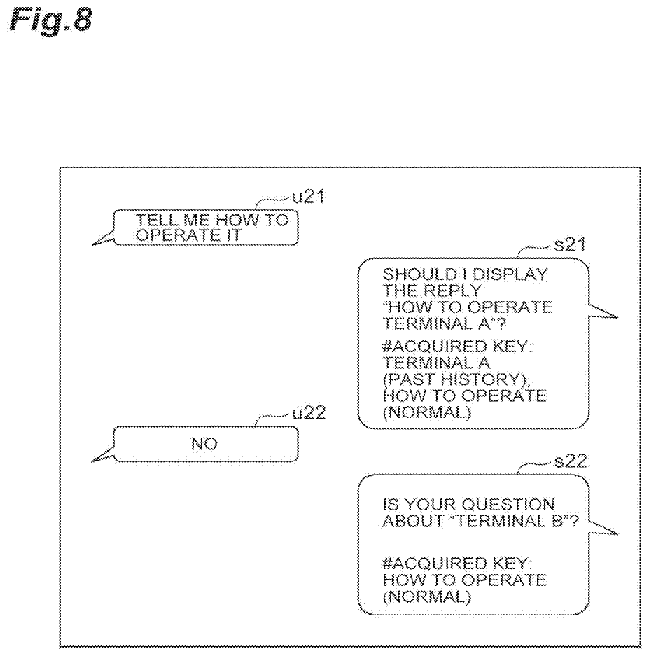

In the above dialogue screen, a return question keyword is acquired from the history database 105, and is transmitted, but its question sentence candidate may be transmitted without transmitting the return question keyword. FIG. 8 shows an example of a dialogue screen when a question sentence candidate is transmitted without sending a return question keyword in response to an input keyword.

In the dialogue screen of FIG. 8, the user terminal 200 accepts an input sentence “Tell me how to operate it,” and transmits the accepted input sentence to the dialogue server 100 (balloon u21). In the dialogue server 100, an input keyword is acquired, the truth table database 107 and the history database 105 are referred to, and one question sentence candidate is acquired. Since FIG. 7 is based on an assumption that a plurality of question sentence candidates are acquired, a return question keyword corresponding to one of the question sentence candidates is transmitted in order to narrow down the question sentence candidates. In this example, the dialogue server 100 determines one question sentence candidate from a plurality of question sentence candidates on the basis of the frequency of provision in the history database 105. Thus, one question sentence candidate is transmitted without transmitting a return question keyword.

The user terminal 200 displays the message “Should I display the reply ‘how to operate terminal A’?” transmitted from the dialogue server 100 (balloon s21). Meanwhile, as shown in the drawing, “terminal A (past history)” and “how to operate (normal)” are displayed as acquired keys. Information indicating the origin of a search keyword (past history, normal) is added to each acquired key. Meanwhile, “past history” indicates a search keyword obtained with reference to the history database 105, and “normal” indicates a search keyword acquired from the truth table database 107. Such a notation makes it possible for the user to ascertain what kind of keyword is used to perform a search.

In order to make such a notation, the dialogue server 100 transmits a search keyword and information indicating the origin together when transmitting a question sentence candidate. The user terminal 200 can display a message shown in the balloon s21 by receiving the information.

Here, when the user replies with a negative intention (balloon u22), the search unit 102 in the dialogue server 100 acquires another search keyword instead of the search keyword selected from the history database 105 (herein, “terminal A”). Here, by referring to the truth table database 107, “terminal B” is acquired as a return question keyword and is transmitted.

In this manner, in a case where a question sentence candidate containing the search keyword acquired from the history database 105 is negated, it can be determined that the search keyword acquired from the history database 105 is not a keyword desired by the user. Therefore, in that case, it is preferable for the search unit 102 to refer to the truth table database 107, acquire another search keyword, and cause the user to confirm the acquired search keyword as a return question keyword.

Next, processing using a modification example of the history database 105 will be described. In this modification example, search path information is stored in the history database 105, and a search based thereon is performed.

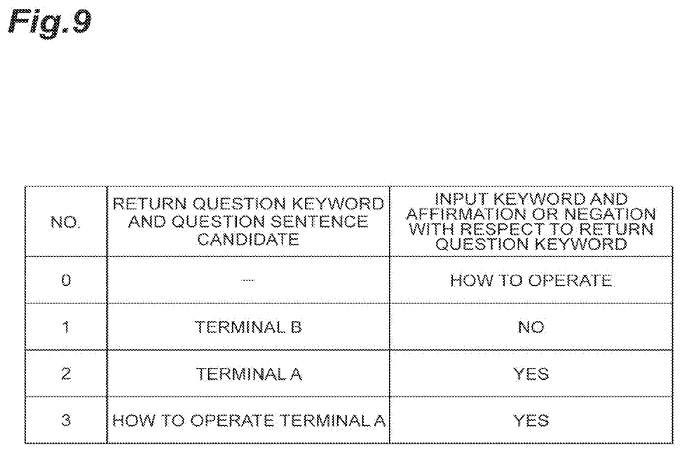

FIG. 9 shows a specific example of the history database 105 in a modification example. As shown in FIG. 9, the history database 105 stores a return question keyword and a question sentence candidate, and the user's response (including an input keyword) in association with each other in a time-series manner. Meanwhile, the time-series association is not necessarily required, and a return question keyword, its affirmative or negative intention, and a finally determined question sentence candidate may be simply stored in association with each other. The history database 105 is constructed by the history information management unit 104.

The history database 105 stores so-called search path information. In the example of FIG. 9, only one piece of search path information is shown, but a plurality of pieces of search path information are stored for each search ID. Meanwhile, a path until a user performs an input to obtain a question sentence and a reply thereto as a search result is defined as one search, and the history information management unit 104 assigns an ID for each search and stores the assigned ID in the history database 105.

In the example of FIG. 9, the history database 105 stores “terminal B” and “terminal A” in that order as return question keywords, and stores “how to operate terminal A” last as a question sentence candidate. On the other hand, “how to operate” is stored as an input keyword, and affirmative or negative intentions of “NO” for “terminal B,” “YES” for “terminal A,” and “YES” for the question sentence candidate “how to operate terminal A” are stored.

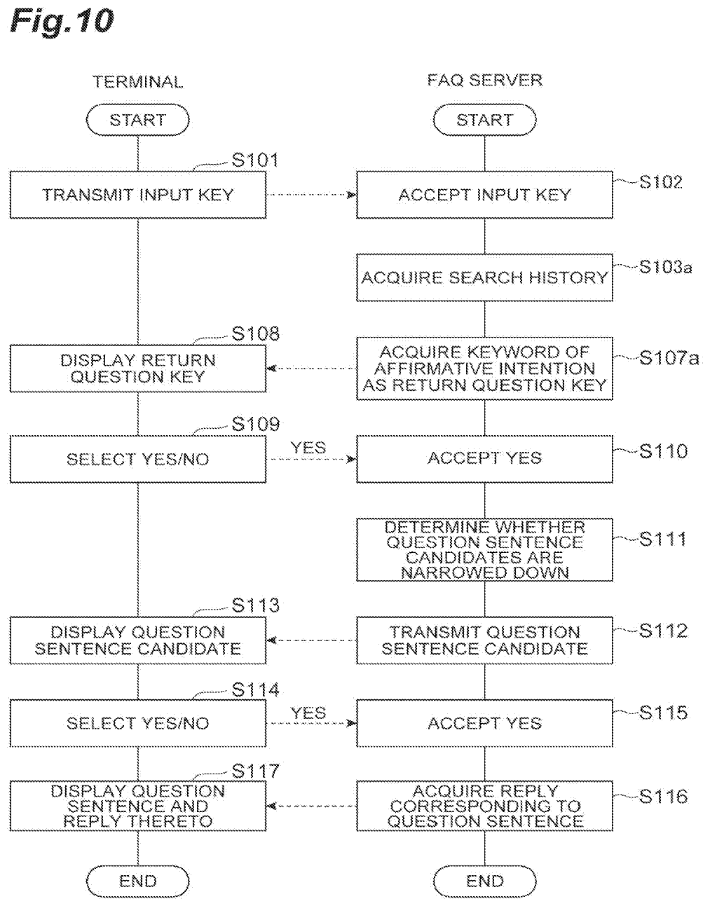

Next, processing using the history database 105 that stores this search path information will be described. FIG. 10 is a sequence diagram illustrating the processing. Processes S101 and S102, process S108 and the subsequent processes are the same as in FIG. 4 or the like. As shown in FIG. 10, in the dialogue server 100, when the reception unit 101 acquires an input keyword, the search unit 102 refers to the history database 105, and acquires one or a plurality of pieces of search path information corresponding to the acquired input keyword (S103a).

In the example of FIG. 9, the search unit 102 uses the input keyword “how to operate” from the user terminal 200 as a key, to acquire one or a plurality of pieces of search path information from the history database 105. Next, the search unit 102 acquires a return question keyword showing an affirmative intention (S107a). In the example of FIG. 9, the search unit 102 acquires “terminal A.” The transmission unit 103 transmits “terminal A” as a return question keyword to the user terminal 200. In the user terminal 200, in a case where an affirmative intention with respect to the return question keyword is indicated, the dialogue server 100 refers to the history database 105, acquires a question sentence candidate corresponding to an affirmative intention, transmits the acquired candidate to the user terminal 200, and provides a question sentence and a reply thereto to the user terminal 200 (S108 to S117). Meanwhile, when other search path information is acquired in S103a in a case where the indication of a negative intention is accepted in process S110, the dialogue server 100 transmits a return question keyword corresponding to an affirmative intention in other search path information to the user terminal 200. Meanwhile, there is no limitation thereto, and a return question keyword may be acquired from the truth table database 107 without referring to the history database 105.

In addition, in a case where question sentence candidates cannot be narrowed down in process S112, it is preferable for the search unit 102 to further acquire a keyword showing an affirmative intention as a return question keyword from the history database 105 and transmit the acquired keyword.

Meanwhile, in a case where the history database 105 in this modification example stores return question keywords in order of time series, it is preferable to acquire return question keywords corresponding to an affirmative intention in that order.

In the above description, the search unit 102 acquires one piece of search path information with respect to input keywords, but a plurality of pieces of search path information may be naturally acquired. In that case, question sentence candidates can be narrowed down early by selecting return question keywords of an affirmative intention in each piece of search path information in order. In addition, in a case where the question sentence candidates are narrowed down to one at a point in time at which combinations of input keywords and return question keywords coincide with each other, the question sentence candidate may be selected.

Next, the operational effect of the dialogue server 100 of the present embodiment will be described. The dialogue server 100 of the present embodiment is a dialogue server that performs a response for prompting the user to make an additional input with respect to the user's input (transmission of a return question keyword), and provides response content according to the user's input (a question sentence or a question sentence candidate).

The dialogue server 100 includes the history database 105 which is a history storage unit that stores history information based on an input performed by one user or another user, the reception unit 101 that receives an input sentence from the user terminal 200 of one user and acquires an input keyword therefrom, the search unit 102 that, when an input keyword is acquired, performs a search on the basis of the input keyword and history information, and the transmission unit that transmits response content (a question sentence candidate) based on a search of the search unit 102 to the user terminal 200.

With such a configuration, the dialogue server 100 makes a further input of an input keyword unnecessary by performing a search on the basis of history information in addition to an input keyword. Thus, it is possible to reduce the amount of dialogue for a search.

Reducing the amount of dialogue for a search involves, that is, reducing the processing load of a processor that takes charge of a control process of the dialogue server 100. Further, in a case where the dialogue server 100 and the user terminal 200 are communicatively connected to each other through a communication network, the effect of making it possible to reduce the traffic amount of the communication network and to reduce a network load is exhibited.

In addition, the search unit 102 in the dialogue server 100 acquires a return question keyword for prompting the user to make an additional input when a plurality of pieces of response content are searched for, and the transmission unit 103 transmits the return question keyword to the user terminal 200.

With such a configuration, even in a case where response content such as a question sentence candidate cannot be narrowed down using history information alone, the response content can be narrowed down.

In addition, in the dialogue server 100, the history database 105 stores response content provided to one user or another user and the frequency of provision of the response content, as history information. The search unit 102 performs a search using keywords constituting response content determined on the basis of the frequency of provision in the history information.

With such a configuration, probable response content (a question sentence candidate) desired by the user can be provided by selecting a keyword on the basis of the frequency of provision of response content (a question sentence candidate) stored as the history information. Therefore, it is possible to avoid an unnecessary dialogue, and to reduce the amount of dialogue for a search.

In addition, in the dialogue server 100, the history database 105 stores search path information in which an input keyword and a return question keyword for prompting the user to make an additional input are described as history information. The search unit 102 performs a search using the input keyword or the return question keyword.

With such a configuration, it is possible to ascertain a search path by storing a return question key as the history information, and to acquire a return question keyword on the basis of the search path. Therefore, it is possible to reduce the amount of dialogue for a search.

In addition, in the dialogue server 100, it is preferable for the search path information to be an input keyword and a return question keyword when the user acquires final response content.

The acquisition of final response content is a search path to a correct answer. Therefore, the amount of dialogue can be reduced by performing a search based on a return question keyword according to the path.

In addition, the search unit 102 of the dialogue server 100 performs a search without using the history information when a negative intention is shown by the user with respect to response content (a question sentence candidate) searched for on the basis of the history information.

With such a configuration, a search is performed without using the history information when the return question keyword according to the history information is negated by a user. Thus, it is possible to reduce the amount of dialogue.

In addition, in the dialogue server 100, the transmission unit 103 adds information indicating an acquisition keyword obtained from the history information and information indicating an input keyword among keywords used in order to search for response content (a question sentence candidate), and transmits the acquisition keyword and the input keyword together with the response content (the question sentence candidate).

With such a configuration, in the user terminal 200, it is possible to recognize a return question keyword acquired by the history information. Therefore, the user can know with what intention the return question keyword is transmitted.

Meanwhile, the block diagram used in the description of the above embodiment represents blocks in units of functions. These functional blocks (constituent elements) are realized by any combination of hardware and/or software. In addition, means for realizing each functional block is not particularly limited. That is, each functional block may be realized by one device which is physically and/or logically coupled, or may be realized by two or more devices which are physically and/or logically separated from each other by connecting the plurality of devices directly and/or indirectly (for example, wiredly and/or wirelessly).

For example, the dialogue server 100, the user terminal 200 or the like in an embodiment of the present invention may function as a computer that performs the processing of the present embodiment.

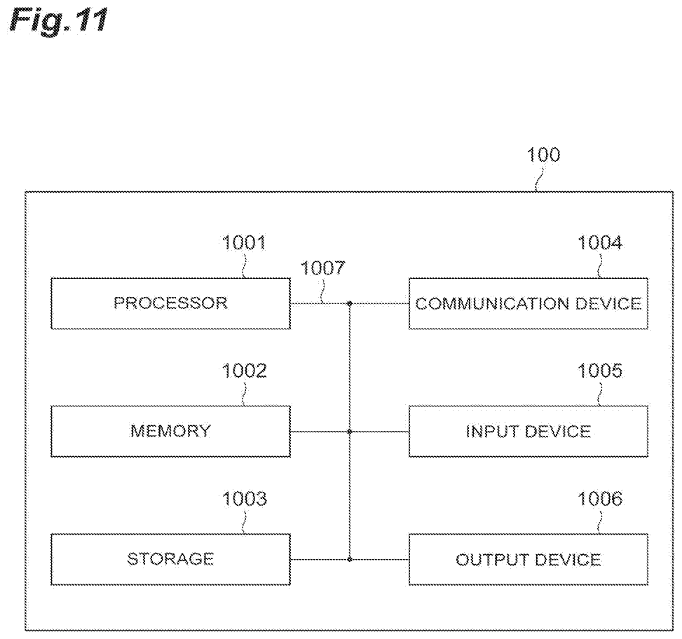

FIG. 11 is a diagram illustrating an example of a hardware configuration of the dialogue server 100 and the user terminal 200 according to the present embodiment. The dialogue server 100 and the user terminal 200 which are described above may be physically configured as a computer device including a processor 1001, a memory 1002, a storage 1003, a communication device 1004, an input device 1005, an output device 1006, a bus 1007, and the like.

Meanwhile, in the following description, the wording “device” may be replaced by a circuit, a device, a unit, or the like. The hardware configurations of the dialogue server 100 and the user terminal 200 may be configured to include one or a plurality of devices shown in the drawings, or may be configured without including some devices.

The processor 1001 performs an arithmetic operation by reading predetermined software (a program) on hardware such as the processor 1001 or the memory 1002, and thus each function in the dialogue server 100 and the user terminal 200 is realized by controlling communication in the communication device 1004 and reading and/or writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, the search unit 102 or the like may be realized by the processor 1001.

In addition, the processor 1001 reads out a program (a program code), a software module and data from the storage 1003 and/or the communication device 1004 into the memory 1002, and executes various types of processes in accordance therewith. An example of the program which is used includes a program causing a computer to execute at least some of the operations described in the foregoing embodiment. For example, the search unit 102 of the dialogue server 100 may be realized by a control program which is stored in the memory 1002 and is operated by the processor 1001, and other functional blocks may also be realized similarly. The execution of various types of processes described above by one processor 1001 has been described, but these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like.

The memory 1002 can store a program (a program code), a software module, or the like that can be executed in order to carry out a wireless communication method according to an embodiment of the present invention.

The storage 1003 is a computer readable recording medium, and may be constituted by at least one of, for example, an optical disc such as a compact disc ROM (CD-ROM), a hard disk drive, a flexible disk, a magnetooptic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including the memory 1002 and/or the storage 1003, a server, or another suitable medium.

The communication device 1004 is hardware (transmitting and receiving device) for performing communication between computers through a wired and/or wireless network, and is also referred to as, for example, a network device, a network controller, a network card, a communication module, or the like. For example, the reception unit 101, the transmission unit 103, and the like may be realized by the communication device 1004.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be constituted by a single bus, or may be constituted by a different bus between devices.

In addition, the dialogue server 100 and the user terminal 200 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, at least one of these types of hardware may be mounted in the processor 1001.

Hereinbefore, the present embodiments have been described in detail, but it is apparent to those skilled in the art that the present embodiments should not be limited to the embodiments described in this specification. The present embodiments can be implemented as modified and changed aspects without departing from the spirit and scope of the present invention, which are determined by the description of the scope of claims. Therefore, the description of this specification is intended for illustrative explanation only, and does not impose any limited interpretation on the present embodiments.

Notification of information is not limited to the aspects/embodiments described in this specification, and may be performed using other methods. For example, the notification of information may be performed by physical layer signaling (such as downlink control information (DCI) or uplink control information (UCI)), upper layer signaling (such as radio resource control (RRC) signaling, medium access control (MAC) signaling, or broadcast information (such as a master information block (MIB) and a system information block (SIB)), other signals, or combinations thereof. In addition, the RRC signaling may be referred to as an RRC message and may be referred to as, for example, an RRC connection setup message or an RRC connection reconfiguration message.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), or other appropriate systems and/or next-generation systems to which these systems are extended on the basis thereof.

The order of the processing sequences, the sequences, the flowcharts, and the like of the aspects/embodiments described above in this specification may be changed as long as they are compatible with each other. For example, in the methods described in this specification, various steps as elements are described in an exemplary order but the methods are not limited to the described specific order.

The input or output information or the like may be stored in a specific place (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects described in this specification may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology are included in the definition of a transmission medium.

Information, a signal or the like described in this specification may be expressed using any of various different techniques. For example, data, an indication, a command, information, a signal, a bit, a symbol, and a chip which can be mentioned in the overall description may be expressed by a voltage, a current, an electromagnetic wave, a magnetic field or magnetic particles, an optical field or photons, or any combination thereof.

Meanwhile, the terms described in this specification and/or the terms required for understanding this specification may be substituted by terms having the same or similar meanings.

The terms “system” and “network” which are used in this specification are used interchangeably.

A mobile communication terminal such as a user terminal may also be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The term “determining” which is used in this specification may include various types of operations. The term “determining” may include regarding operations such as, for example, judging, calculating, computing, processing, deriving, investigating, looking up (for example, looking up in a table, a database or a separate data structure), or ascertaining as an operation such as “determining” In addition, the term “determining” may include regarding operations such as receiving (for example, receiving information), transmitting (for example, transmitting information), input, output, or accessing (for example, accessing data in a memory) as an operation such as “determining.” In addition, the term “determining” may include regarding operations such as resolving, selecting, choosing, establishing, or comparing as an operation such as “determining.” That is, the term “determining” may include regarding some kind of operation as an operation such as “determining.”

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. In this specification, two elements can be considered to be “connected” or “coupled” to each other when one or more electrical wires, cables, and/or printed electric connections are used or by using electromagnetic energy such as electromagnetic energy having wavelengths in a radio frequency range, a microwave area, and a light (both visible light and invisible light) area as non-restrictive and non-comprehensive examples.

An expression “on the basis of ˜” which is used in this specification does not refer to “on the basis of only ˜,” unless otherwise described. In other words, the expression “on the basis of ˜” refers to both “on the basis of only ˜” and “on the basis of at least ˜.”

Any reference to elements having names such as “first” and “second” which are used in this specification does not generally limit amounts or an order of the elements. The terms can be conveniently used to distinguish two or more elements in this specification. Accordingly, reference to first and second elements does not mean that only two elements are employed or that the first element has to precede the second element in any form.

Insofar as the terms “include” and “including” and modifications thereof are used in this specification or the claims, these terms are intended to have a comprehensive meaning similarly to the term “comprising.” Further, the term “or” which is used in this specification or the claims is intended not to mean an exclusive logical sum.

In this specification, a single device is assumed to include a plurality of devices unless only one device may be present in view of the context or the technique.

### REFERENCE SIGNS LIST

100 Dialogue server, 101 Reception unit, 102 Search unit, 103 Transmission unit, 104 History information management unit, 105 History database, 106 FAQ database, 107 Truth table database, 200 User terminal

1. A dialogue server configured to perform a response for prompting a user to make an additional input with respect to the user's input and provide response content according to the user's input, the dialogue server comprising:
a history storage unit configured to store history information based on an input performed by one user or another user;
an acceptance unit configured to accept an input keyword from a user terminal of the one user;
a search unit configured to perform a search on the basis of the input keyword and the history information when the input keyword is accepted; and
a transmission unit configured to transmit response content based on a search of the search unit to the user terminal.

2. The dialogue server according to claim 1, wherein the search unit acquires a return question keyword for prompting the user to make an additional input when a plurality of pieces of response content are searched for, and
the transmission unit transmits the return question keyword to the user terminal.

3. The dialogue server according to claim 1, wherein the history storage unit stores response content provided to the one user or another user and a frequency of provision of the response content as history information, and
the search unit performs a search using keywords constituting response content determined on the basis of the frequency of provision in the history information.

4. The dialogue server according to claim 1, wherein the history storage unit stores search path information in which an input keyword and a return question keyword for prompting the user to make an additional input are described as history information, and
the search unit performs a search using the input keyword or the return question keyword.

5. The dialogue server according to claim 4, wherein the search path information is an input keyword and a return question keyword when the user acquires final response content.

6. The dialogue server according to claim 1, wherein the search unit performs a search without using the history information when a negative intention is shown by the user with respect to response content searched for on the basis of the history information.

7. The dialogue server according to claim 1, wherein the transmission unit adds information indicating an acquisition keyword obtained from the history information and information indicating an input keyword among keywords used in order to search for the response content, and transmits the acquisition keyword and the input keyword together with the response content.

8. The dialogue server according to claim 2, wherein the history storage unit stores response content provided to the one user or another user and a frequency of provision of the response content as history information, and
the search unit performs a search using keywords constituting response content determined on the basis of the frequency of provision in the history information.

9. The dialogue server according to claim 2, wherein the history storage unit stores search path information in which an input keyword and a return question keyword for prompting the user to make an additional input are described as history information, and
the search unit performs a search using the input keyword or the return question keyword.

10. The dialogue server according to claim 2, wherein the search unit performs a search without using the history information when a negative intention is shown by the user with respect to response content searched for on the basis of the history information.

11. The dialogue server according to claim 2, wherein the transmission unit adds information indicating an acquisition keyword obtained from the history information and information indicating an input keyword among keywords used in order to search for the response content, and transmits the acquisition keyword and the input keyword together with the response content.
